(19) United States
(12) Patent Application Publication
(10) Pub. No.: US 2015/0328960 A1
(43) Pub. Date: Nov. 19, 2015

(54) HVAC VENT UTILIZING VORTEX RING AIR FLOW

(71) Applicant: GM GLOBAL TECHNOLOGY OPERATIONS LLC, Detroit, MI (US)

(72) Inventor: Brian V. Castillo, Birmingham, MI (US)

(73) Assignee: GM GLOBAL TECHNOLOGY OPERATIONS LLC, Detroit, MI (US)

(21) Appl. No.: 14/277,883

(22) Filed: May 15, 2014

(51) Int. Cl. B60H 1/34

(52) U.S. Cl. CPC B60H 1/3457; B60H 2001/3471

(57) ABSTRACT

An HVAC vent is provided. The HVAC vent includes a housing and an electro-mechanical diaphragm. The housing defines an air inlet for receiving cooling air from an HVAC module, an air chamber for enclosing the air received, and an air outlet configured to facilitate the generation of vortex rings. The electro-mechanical diaphragm is connected to the housing and cooperates with the configured air outlet and the receipt of cooling air from the HVAC module to project the received cooling air in the air chamber out of the air outlet as generated vortex rings.

### TECHNICAL FIELD

The disclosure relates to an HVAC vent manufacture configured for generation of vortex rings.

### BACKGROUND

An HVAC (Heating, Ventilation, and Air Conditioning) system for a vehicle typically includes an HVAC module, a duct or air distribution system, and one or more vents. The HVAC module produces a steady flow of conditioned air, which may be either heated or cooled, or ambient air for ventilation. The duct or air distribution system contains the steady flow of conditioned or ambient air and routes it from the HVAC module to the one or more vents. The vent or vents may be grilles and are typically located at the periphery of a space where the conditioned air is needed for the comfort of one or more occupants of the space. Each of the vent or vents include an air inlet side, which receives the steady flow of conditioned or ambient air, and an air outlet side, from which the steady flow of conditioned or ambient air is directed into the space to be heated, ventilated, or cooled.

When the space is uncomfortably hot for the occupants, the HVAC system is used to deliver cooling air to the space. However, the steady flow of cooling air from the vent or vents may not be sufficient to reach the occupants of a space remote from the vent or vents. Although the cooling air flow may eventually cool the entire space and its occupants, it will not immediately cool the occupants unless the cooling air flow reaches them. Immediate occupant cooling can be greatly enhanced by projecting the cooling air flow from the vent or vents to reach the skin and clothing of the occupants. Locating the vent or vents close to all of the occupants may require costly, complex, and space consuming additions to the air distribution system and may also require additional vents.

### SUMMARY

An HVAC vent is provided. The HVAC vent includes a housing or an HVAC air chamber and an electro-mechanical diaphragm. The housing or HVAC air chamber is configured to define an air inlet for receiving cooling air from an HVAC module, an air chamber for enclosing the air received, and an air outlet configured to facilitate the generation of vortex rings. The electro-mechanical diaphragm is connected to the housing or HVAC air chamber and cooperates with the configuration of the air outlet and the receipt of cooling air from the HVAC module to project the received cooling air in the air chamber out of the air chamber through the air outlet as generated vortex rings.

The HVAC air chamber may be substantially frustoconical in shape. The HVAC air chamber or housing may include a feature at the air outlet that is substantially an annular ridge that surrounds the air outlet. And, the HVAC air chamber may include a valve for controlling the air being received by or at the air inlet.

A vehicle is also provided. The vehicle includes a first seat that is occupiable by a driver, a second row of seats that is occupiable by one or more passengers, an HVAC module for cooling air, and a cooling air distribution system having an HVAC vent oriented sufficiently with respect to the second row of seats to enable cooling air to be projected toward the second row of seats. The HVAC vent is characterized as an electro-mechanical vortex ring generator that has a controlled air inlet for receiving cooling air from the HVAC module and an air outlet. The vortex ring generator is configured as a hollow conical member having on one side of the air inlet an annular ridge forming the air outlet and on the other side of the air inlet an electro-mechanical diaphragm of nonporous material. The electro-mechanical diaphragm cooperates sufficiently with the cooling air entering from the controlled air inlet to generate and project one or more vortex rings sufficient to reach the second row of seats and any passengers occupying those seats.

The vehicle may also include a third row of seats rearward of the second row of seats that are occupiable by one or more passengers. In this embodiment, the vent is oriented sufficiently with respect to the second and third rows of seats to enable cooling air to be projected toward the second and third rows of seats, and the diaphragm cooperates sufficiently with the cooling air entering from the controlled air inlet to generate and project one or more vortex rings sufficient to reach the second and third rows of seats and any passengers occupying those seats.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic top view section of a vehicle that has first, second, and third rows of seats and includes two HVAC vents to facilitate vortex ring air flow of cooling air from an HVAC module;

FIG. 2 is a schematic cross-section of one of the HVAC vents of FIG. 1 to show an air inlet receiving and controlling the cooling air being received from the HVAC module and a diaphragm retractable in one direction as the cooling air is received from the HVAC module;

FIG. 3 is a schematic cross-section of the HVAC vent of FIG. 2 to show an air outlet configuration in cooperation with the diaphragm projectable in another direction to generate and project a vortex ring or rings of the cooling air received; and

FIG. 4 is a schematic perspective view of the resultant air flow to be projected as one or more rings such as the shown vortex rings generated by the HVAC vent of FIG. 3.

### DETAILED DESCRIPTION

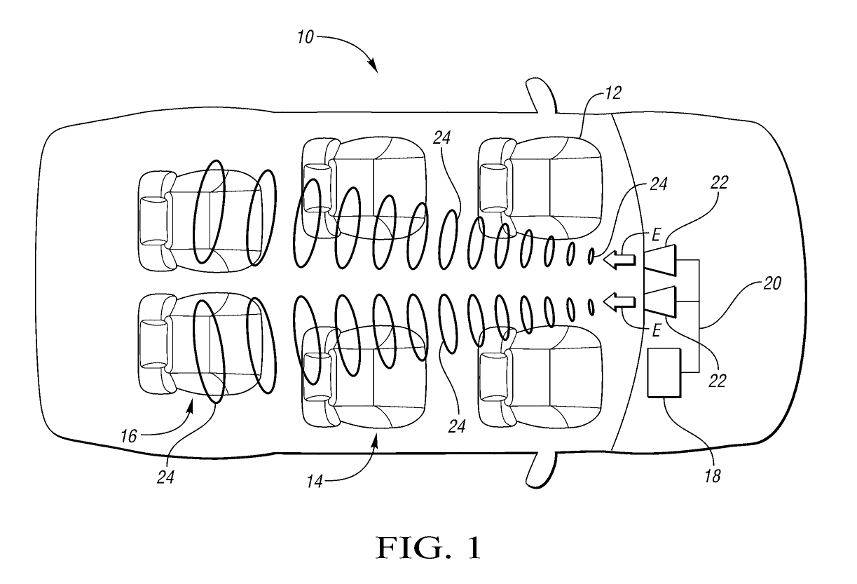

Referring to the drawings, wherein like reference numbers refer to like components throughout the views, FIG. 1 shows vehicle 10 having a first seat 12 occupiable by a driver, a second row of seats 14 rearward of the first seat 12 and occupiable by one or more passengers, and a third row of seats 16 rearward of the second row of seats 14 and occupiable by one or more passengers. The vehicle may be a car, truck, sport utility vehicle, van, bus, or any other vehicle having more than one row of seats.

The vehicle 10 also has an HVAC (Heating, Ventilating, and Air Conditioning) module 18 for cooling air and a cooling air distribution system 20. The HVAC module 18 produces a steady flow of cooling air. The cooling air distribution system 20 contains the steady flow of cooling air and routes it from the HVAC module 18 to a vent or vents 22. Each vent 22 may be characterized as an electro-mechanical vortex ring generator and is oriented sufficiently with respect to the second and third rows of seats 14, 16 to enable the cooling air to be projected toward the second and third rows of seats 14, 16. The vent or vents 22 may be located forward of the first seat 12, or the vent or vents 22 may be located in other areas of the vehicle 10.

Each vent 22 may generate a vortex ring 24 that projects cooling air toward the second and third rows of seats 14, 16. The direction of the vortex ring 24 in motion is shown by arrow E. A vent 22 need not be located forward of the first seat 12. The vent or vents 22 may also be used in vehicles with no third row of seats 16 or in vehicles with more than three rows of seats. Vortex ring 24 air flow will be described in greater detail below, with reference to FIG. 4.

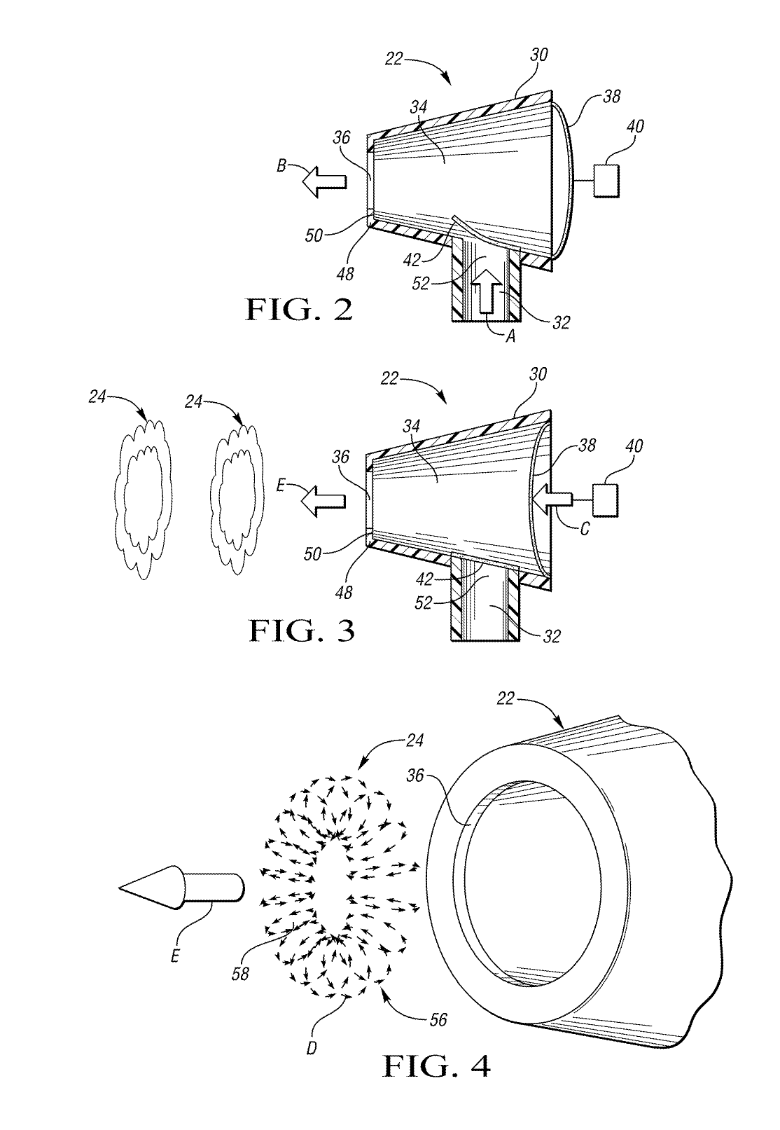

Referring now to FIG. 2, a vent 22 includes a housing 30 and an electro-mechanical diaphragm 38. The housing 30 may be made of a metal, a non-metal, or of any other suitable material. The electro-mechanical diaphragm 38 may be flexible and may be made of a nonporous material. The electro-mechanical diaphragm 38 may be made of a metal, a non-metal, a coated fabric, a composite material, or a combination of these materials. The electro-mechanical diaphragm 38 may be moveable (retractable and projectable) and actuatable by an electro-mechanical actuator 40. The electro-mechanical diaphragm 38 may include the electro-mechanical actuator 40.

The housing 30 defines an air inlet 32 for receiving cooling air from the HVAC module 18. The direction of cooling air flow into the air inlet 32 is shown by arrow A. The air inlet 32 may be controlled at the controlled air inlet 52 and may include a valve 42 for the air entering at air inlet 32. The valve 42 may be a one-way valve or a reed valve.

The housing 30 also defines an air chamber 34 for enclosing the cooling air received. The air chamber 34 may be configured as a hollow conical member or may be substantially frustoconical in shape. The air chamber 34 may also be substantially cylindrical in shape.

The housing 30 also defines an air outlet 36 configured to facilitate the generation of vortex rings. When the air chamber is full of cooling air, cooling air entering the air inlet 32 may flow out of the air outlet 36 in the direction of arrow B. The housing 30 may include a feature 48 at the air outlet 36. The feature 48 may be configured as an annular ridge 50 surrounding the air outlet 36.

The vent 22 may be configured having on one side of the air inlet 32 the annular ridge 50 forming the air outlet 36 and on the other side of the air inlet 32 the electro-mechanical diaphragm 38.

Referring now to FIG. 3, the electro-mechanical diaphragm 38 is connected to the housing 30 and is cooperable with the configured air outlet 36 and the receipt of cooling air from the HVAC module 18 (FIG. 1) to generate and project the received cooling air in the air chamber 34 out of the air outlet 36 as generated vortex rings 24. Specifically, the electro-mechanical actuator 40 may apply a force (projection) to the electro-mechanical diaphragm 38, moving it in the direction of arrow C to compress and pressurize the cooling air inside of the air chamber 34. The increased pressure in the air chamber 34 may close the valve 42 and generate the vortex ring 24 as the electro-mechanical diaphragm 38 projects. The resultant vortex ring 24 thus generated, then projects in the direction of arrow E toward the second and third rows of seats 14, 16, as best shown in FIG. 1.

As best shown in FIG. 2, the electro-mechanical actuator 40 may then remove or retract the force applied to the electro-mechanical diaphragm 38. This allows the electro-mechanical diaphragm 38 to return or retract to its original position, thus allowing valve 42 to open, and allowing cooling air to again enter and fill the air chamber 34 in preparation for a generation of the next vortex ring 24.

This sequence is repeated at a predetermined frequency which is appropriate for generating sufficient vortex rings 24 to project toward and reach the second and third rows of seats 14, 16 and any passengers occupying those seats. The electro-mechanical diaphragm 38 may be actuatable at a frequency of less than 20 Hertz.

If desired, the vent 22 may also be operated as a conventional HVAC vent by simply not actuating the electro-mechanical diaphragm 38. In this mode of operation, as best shown in FIG. 2, cooling air flows into the vent 22 at the air inlet 32 in the direction of arrow A, passes through the chamber 34, and flows out of the vent 22 at the air outlet 36 in the direction of arrow B. This mode of operation may be desired after the entire space has been cooled to a temperature that is comfortable for all of the occupants.

Referring now to FIG. 4, sufficient vortex rings such as the vortex ring 24 of cooling air are projected in the direction of arrow E out of the air outlet 36 and toward the second and third rows of seats 14, 16 to reach any passengers occupying those seats. The projected vortex rings 24 of cooling air are in a toroidal (or doughnut) shape 56. The toroidal shape 56 of each vortex ring 24 is formed by a poloidal flow 58 of the cooling air within the toroidal shape 56. Poloidal flow is defined as fluid flow that spins around a circular axis that forms a circumferential loop around a pole axis. In FIG. 4, the pole axis is arrow E, which is located at the center of and perpendicular to the air outlet 36. The toroidal shape 56 has a circular axis (not shown) that forms a circumferential loop around the pole axis at the center of the toroidal shape 56. The poloidal flow 58 of cooling air within the toroidal shape 56 of each vortex ring 24 is shown by circular arrow D.

Each vortex ring 24 travels in the direction of arrow E, carrying its poloidal flow 58 of cooling air with it. The poloidal flow 58 of each vortex ring 24 lessens the friction between the vortex ring 24 and the surrounding air as the vortex ring moves in the direction of arrow E. This enables each vortex ring 24 to travel a long distance with little loss of mass and kinetic energy. Thus, a projected vortex ring 24 can carry cooling air farther than a projected steady flow or jet of cooling air.

The provided HVAC vent applies to any type of vehicle, including but not limited to cars, trucks, SUVs, vans, busses, trains, airplanes, and boats. It may also apply to non-vehicular spaces where rapid occupant cooling is desired. These spaces may include, but are not limited to, rooms and hallways in buildings, partially enclosed spaces, and unenclosed spaces. The provided HVAC vent applies to spaces where the occupants are either seated or unseated.

While the best modes for carrying out the many aspects of the present teachings have been described in detail, those familiar with the art to which these teachings relate will recognize various alternative aspects for practicing the present teachings that are within the scope of the appended claims.

1. An HVAC vent manufacture comprising:
a housing configured to define an air inlet for receiving cooling air from an HVAC module, an air chamber for enclosing the air received, and an air outlet configured to facilitate the generation of a vortex ring; and
an electro-mechanical diaphragm connected to the housing and cooperable with the air outlet for projecting the received cooling air in the air chamber out of the air outlet as a generated vortex ring.

2. The HVAC vent manufacture of claim 1, further comprising a valve for the air inlet.

3. The HVAC vent manufacture of claim 2, wherein the valve is a one-way valve.

4. The HVAC vent manufacture of claim 3, wherein the valve is a reed valve.

5. The HVAC vent manufacture of claim 1, wherein the electro-mechanical diaphragm is made of a nonporous material.

6. The HVAC vent manufacture of claim 1, wherein the electro-mechanical diaphragm is actuatable at a frequency of less than 20 Hertz.

7. The HVAC vent manufacture of claim 1, wherein the air chamber defined by the housing is substantially frustoconical in shape.

8. The HVAC vent manufacture of claim 1, wherein the housing includes a feature at the air outlet and more vortex rings are generated.

9. The HVAC vent manufacture of claim 8, wherein the feature is substantially an annular ridge surrounding the air outlet.

10. The HVAC vent manufacture of claim 7, wherein the housing includes a feature at the air outlet.

11. The HVAC vent manufacture of claim 10, wherein the feature is substantially an annular ridge surrounding the air outlet.

12. The HVAC vent manufacture of claim 1, further comprising a valve for the air inlet and a feature at the air outlet;
wherein the valve is a one-way reed valve; wherein the feature is substantially an annular ridge surrounding the air outlet; wherein the air chamber defined by the housing is substantially frustoconical in shape; and wherein the electro-mechanical diaphragm is made of a nonporous material.

13. A vehicle comprising:
a first seat occupiable by a driver;
a second row of seats rearward of the first seat and occupiable by one or more passengers;
an HVAC module for cooling air; and
a cooling air distribution system having a vent oriented sufficiently with respect to the second row of seats to enable cooling air to be projected toward the second row of seats;
wherein the vent is characterized as an electro-mechanical vortex ring generator having a controlled air inlet for receiving cooling air from the HVAC module and an air outlet; the vortex ring generator being configured as a hollow conical member having on one side of the air inlet an annular ridge forming the air outlet and on the other side of the air inlet an electro-mechanical diaphragm of nonporous material; the diaphragm cooperating sufficiently with the cooling air entering from the controlled air inlet to generate and project one or more vortex rings sufficient to reach the second row of seats.

14. The vehicle of claim 13, further comprising a third row of seats rearward of the second row of seats;
wherein the vent is oriented sufficiently with respect to the second and third rows of seats to enable the cooling air to be projected as one or more vortex rings toward the third row of seats; and
wherein the diaphragm cooperates sufficiently with the cooling air entering from the controlled air inlet to generate and project sufficient vortex rings to reach the second and third rows of seats.

15. The vehicle of claim 13, wherein the controlled air inlet includes a reed valve.

16. The vehicle of claim 14, wherein the controlled air inlet includes a reed valve.

17. The vehicle of claim 13, wherein the electro-mechanical diaphragm is actuatable at a frequency of less than 20 Hertz.

18. The vehicle of claim 14, wherein the electro-mechanical diaphragm is actuatable at a frequency of less than 20 Hertz.

19. A vehicle comprising:
a first seat occupiable by a driver;
a second row of seats rearward of the first seat and occupiable by one or more passengers;
an HVAC module for cooling air; and
a cooling air distribution system having a vent forward of the first seat and oriented sufficiently with respect to the second row of seats to enable cooling air to be projected toward the second row of seats, the vent comprising:
a housing configured to define an air inlet for receiving cooling air from an HVAC module, an air chamber for enclosing the air received, and an air outlet configured to facilitate the generation of vortex rings; and
an electro-mechanical diaphragm of nonporous material connected to the housing and cooperable with the air outlet to generate and project the received cooling air in the air chamber out of the air outlet as generated vortex rings; and
wherein the vent generates and projects sufficient vortex rings to reach the second row of seats.

20. The vehicle of claim 19, further comprising a third row of seats rearward of the second row of seats and occupiable by one or more passengers;
wherein the vent is oriented sufficiently with respect to the second and third rows of seats to enable cooling air to be projected toward the second and third rows of seats; and
wherein the vent generates and projects sufficient vortex rings to reach the second and third rows of seats.
